(19) United States
(12) Patent Application Publication
(10) Pub. No.: US 2022/0055765 A1
(43) Pub. Date: Feb. 24, 2022

(54) Exhaust System For Aerial Vehicle

(71) Applicant: Sonin Hybrid, LLC, Atlanta, GA (US)

(72) Inventors: Curtis Asa Foster, Lawrenceville, GA (US); Raymond Samuel Trey Davenport, III, Gillsville, GA (US)

(21) Appl. No.: 17/408,853

(22) Filed: Aug. 23, 2021

Related U.S. Application Data
(60) Provisional application No. 63/069,178, filed on Aug. 24, 2020.

(51) Int. Cl. F02K 1/34; F01N 1/16; F01N 1/04; F01N 13/00

(52) U.S. Cl. CPC B64D 33/06; F01N 13/001; F01N 1/04; F01N 1/166

(57) ABSTRACT

An aerial vehicle that can comprise a housing comprising an outer wall at least partially defining an interior space, a mechanical power source at least partially located in the interior space of the housing, an exhaust header in communication with the mechanical power source for communicating exhaust fluid from the mechanical power source, and an exhaust system comprising at least an exhaust chamber extending at least partially in the interior space of the housing. The exhaust chamber can be in communication with the exhaust header, and the exhaust system can comprise an exhaust outlet for communicating the exhaust fluid from the exhaust system outside the aerial vehicle.

### CROSS-REFERENCE TO RELATED APPLICATIONS

This application claims the benefit of U.S. Provisional Patent Application No. 63/069,178 filed on Aug. 24, 2020.

### INCORPORATION BY REFERENCE

The disclosure of U.S. Provisional Patent Application No. 63/069,178, which was filed on Aug. 24, 2020, is hereby incorporated by reference for all purposes as if presented herein in its entirety.

### TECHNICAL FIELD

The present disclosure relates to exhaust systems and aerial vehicles, and more particularly, to exhaust chambers for aerial vehicles. Other aspects also are described.

### BACKGROUND

Aerial vehicles such as drones or other unmanned or uncrewed aerial vehicles are becoming increasingly prevalent in numerous fields (e.g., aerial photography, package delivery, agriculture, surveillance, recreational uses, etc.). Existing systems can produce a significant amount of noise that can be disruptive to people and/or animals in the vicinity of the vehicle (e.g., in residential areas, on film sets, in areas with livestock, etc.) and/or can alert nearby individuals of the presence of a vehicle in situations where stealth is desired. Accordingly, it can be seen that a need exists for providing aerial vehicles and similar apparatuses with systems that can reduce or mitigate the overall noise profile thereof.

### SUMMARY

In general, one aspect of the disclosure can be directed to an aerial vehicle, such as a drone. The aerial vehicle can include a hybrid aerial vehicle. For example, the aerial vehicle can include a housing, a mechanical power source, such as an internal combustion engine, mounted to the housing for generating lift by driving a rotor and/or electrical energy for charging a battery. The aerial vehicle also can include an exhaust system in fluid communication with the internal combustion engine for receiving exhaust fluids therefrom. The exhaust system can be configured for reducing energy in the exhaust fluids communicated from the mechanical power source to mitigate the overall noise profile of the aerial vehicle.

In one embodiment, the exhaust system can include at least a reactive exhaust chamber with one or more reactive elements and/or perforated portions arranged in an interior of the reactive exhaust chamber for dividing the exhaust fluids into portions, redirecting the portions of the exhaust fluids, and causing interactions between the exhaust fluids to facilitate interference between the portions that can reduce the energy thereof.

Alternatively, or in addition, the exhaust system can include at least an absorptive chamber for receiving the exhaust fluids. In one embodiment, the absorptive chamber can include one or more absorptive materials. The absorptive chamber generally can be in fluid communication with the reactive chamber.

In one embodiment, the exhaust system can include one or more chambers, e.g., the reactive chamber and/or the absorptive chamber, extending in an interior of the housing and can include one or more exhaust outlets in an outer wall of the housing.

Alternatively, or in addition, the aerial vehicle can include a vertical stabilizer extending from the housing and the exhaust system can include one or more chambers, e.g., the absorptive chamber, extending at least partially within the vertical stabilizer.

In another aspect, the disclosure is generally directed to an aerial vehicle that can comprise a housing comprising an outer wall at least partially defining an interior space, a mechanical power source at least partially located in the interior space of the housing, an exhaust header in communication with the mechanical power source for communicating exhaust fluid from the mechanical power source, and an exhaust system comprising at least an exhaust chamber extending at least partially in the interior space of the housing. The exhaust chamber can be in communication with the exhaust header, and the exhaust system can comprise an exhaust outlet for communicating the exhaust fluid from the exhaust system outside the aerial vehicle.

In another aspect, the disclosure is generally directed to an exhaust system for an aerial vehicle. The exhaust system can comprise at least a reactive exhaust chamber in communication with an exhaust header for communicating exhaust fluid from the exhaust header to the reactive exhaust chamber. The reactive exhaust chamber can comprise at least a reactive element extending in the reactive exhaust chamber. The reactive element can be configured for reducing energy in the exhaust fluids communicated from the mechanical power source to mitigate an overall noise profile of the aerial vehicle. The exhaust system further can comprise an exhaust outlet extending in at least a portion of the aerial vehicle for communicating the exhaust fluid from the exhaust system.

In another aspect, the disclosure is generally directed to a tuned exhaust for an aerial vehicle. The tuned exhaust can comprise an exhaust header for communicating exhaust fluid, a first tube, a second tube, and an expansion chamber. The tuned exhaust can be operable to direct the exhaust fluid from the exhaust header through a selected one of the first tube and the second tube to the expansion chamber.

In another aspect, the disclosure is generally directed to a method that can comprise operating an aerial vehicle comprising a housing comprising an outer wall at least partially defining an interior space, a mechanical power source at least partially located in the interior space of the housing, an exhaust header, an exhaust system comprising at least an exhaust chamber extending at least partially in the interior space of the housing and an exhaust outlet. The method further can comprise communicating exhaust fluid from the mechanical power source to the exhaust chamber via the exhaust header and outputting the exhaust fluid from the exhaust system outside the aerial vehicle via the exhaust outlet.

Other aspects, features, and details of the present disclosure can be more completely understood by reference to the following detailed description, taken in conjunction with the drawings and from the appended claims.

### BRIEF DESCRIPTION OF THE DRAWINGS

Those skilled in the art will appreciate the above stated advantages and other advantages and benefits of various additional embodiments reading the following detailed description of the embodiments with reference to the below-listed drawing figures. Further, the various features of the drawings discussed below are not necessarily drawn to scale. Dimensions of various features and elements in the drawings may be expanded or reduced to more clearly illustrate the embodiments of the disclosure.

FIGS. 1A-2B schematically show various views and portions of a hybrid aerial vehicle or drone and other features according to various embodiments of the disclosure.

FIG. 3 is a schematic view of an aerial vehicle showing at least a portion of an exhaust system according to an exemplary embodiment of the disclosure.

FIGS. 4A and 4B are schematic views of at least a portion of an exhaust system of an aerial vehicle with at least a reactive exhaust chamber and an absorptive chamber according to exemplary embodiments of the disclosure.

FIG. 5 is a schematic view of at least a portion of an exhaust system of an aerial vehicle with at least a reactive exhaust chamber in a housing of the aerial vehicle and an absorptive chamber in a vertical stabilizer of the aerial vehicle according to exemplary embodiments of the disclosure.

FIGS. 6A and 6B are schematic views of at least a portion of an exhaust system of an aerial vehicle with at least a tuned exhaust and other features according to exemplary embodiments of the disclosure.

FIGS. 7A and 7B are schematic views of at least a portion of an exhaust system of an aerial vehicle with at least a diverter apparatus and bypass outlet, other adjustable features, and/or other features according to exemplary embodiments of the disclosure.

FIG. 8 is a schematic view of at least a portion of an exhaust system of an aerial vehicle with at least a reactive exhaust chamber and a movable reactive plate and other features according to exemplary embodiments of the disclosure.

FIGS. 9A and 9B are schematic views of at least a portion of an exhaust system of an aerial vehicle having a twin cylinder engine in fluid communication with one or more chambers of an exhaust system and other features according to exemplary embodiments of the disclosure.

Corresponding parts are designated by corresponding reference characters throughout the drawings.

### DETAILED DESCRIPTION

The following description is provided as an enabling teaching of embodiments of this disclosure. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances. Thus, the following description is provided as illustrative of the principles of the embodiments of the invention and not in limitation thereof, since the scope of the invention is defined by the claims.

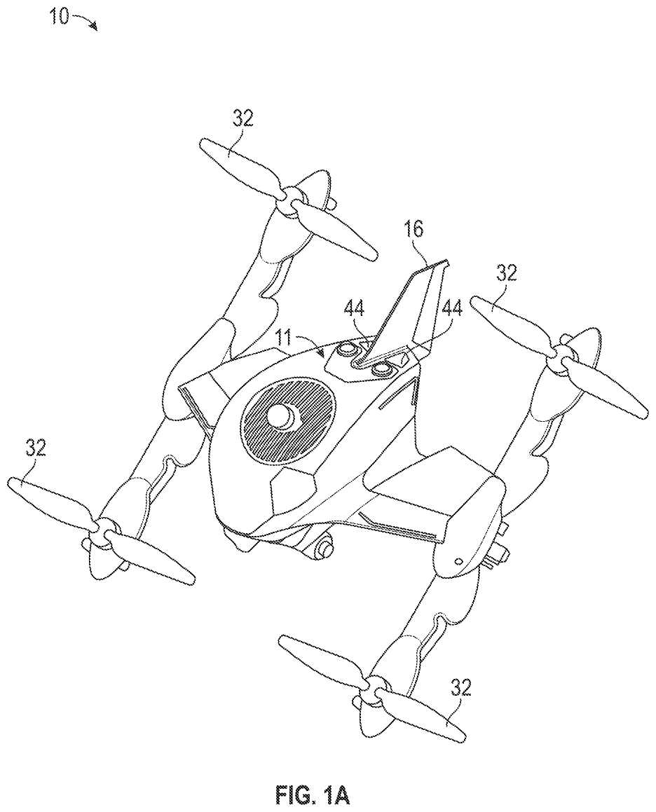

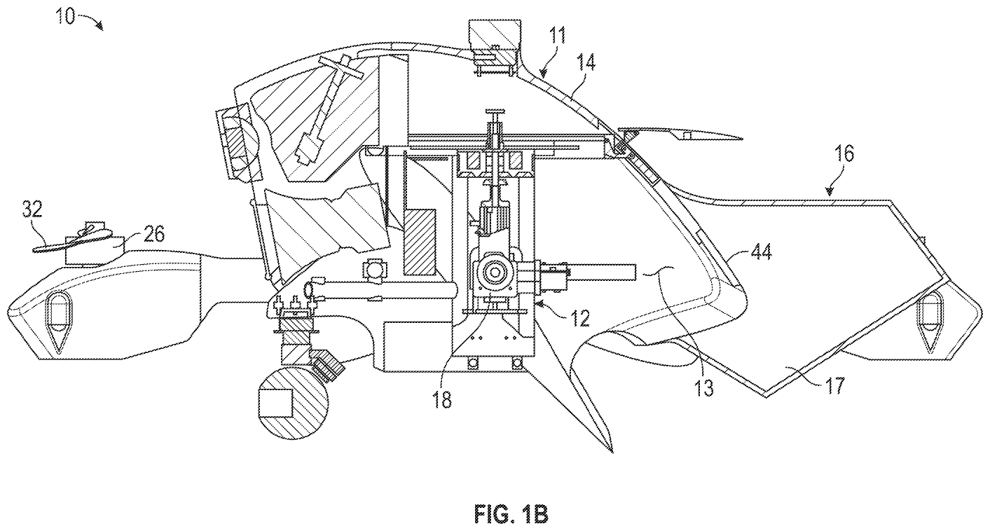

As generally shown in FIGS. 1A and 1B, the present disclosure is directed to an aerial vehicle 10 with a fuselage or housing 11. The aerial vehicle 10 can include a multirotor drone, such as a drone defined by or similar to FAA Part 107 or other similar drones. In some embodiments, the housing 11 can be mounted to a frame or chassis 12 (shown schematically in FIGS. 1B-2B), which can be at least partially contained within an interior space 13 of the housing 11, and the aerial vehicle 10 can include a vehicle controller 15 mounted to the chassis 12 at least partially in the interior 13 of the housing 11. In the illustrated embodiments, the interior 13 of the housing 11 can be at least partially defined by an outer wall 14 of the housing 11 (e.g., as schematically shown in FIG. 1B). In the exemplary embodiments, the vehicle controller can be configured to control operations associated with the aerial vehicle 10, such as propulsion, maneuvering, and operation of various systems of the aerial vehicle 10.

The aerial vehicle 10 further can include one or more electric motors 26 coupled to the chassis 12 and in communication with the vehicle controller and configured to convert electrical power into rotational power. In exemplary embodiments, each of the electric motors 26 can be coupled to one or more propulsion members 32, such as rotors other suitable airfoils (e.g., via a rotating drive shaft). The electric motors 26 can be selectively activated by the vehicle controller to drive rotation of the propulsion members 32 to facilitate lift, maneuvering, etc. of the aerial vehicle 10. While the aerial vehicle 10 shown in FIGS. 1A and 2A is shown as having four electric motors 26 and four propulsion members 32, the aerial vehicle 10 can include any suitable number of electric motors 26 and propulsion members 32, such as six, eight, ten, or more or fewer, without departing from the disclosure. The aerial vehicle 10 includes a power source, such as one or more batteries 21 (e.g., Lithium Polymer (Li—Po) batteries, Lithium Iron Phosphate (LFP) batteries, batteries with other general Lithium-Ion chemistries, other suitable batteries, and/or other suitable power sources), for providing power to the aerial vehicle 10 including the electric motors 26.

In the illustrated embodiments, the aerial vehicle 10 further can include a vertical stabilizer 16, which can be continuous with and/or integral with the housing 11 or can be a separate component that is mounted to the housing 11 and/or the chassis 12. The vertical stabilizer 16 can help stabilize the aerial vehicle 10 during flight and/or can have other suitable aerodynamic and/or vehicle control features and advantages. In addition, in some embodiments, the vertical stabilizer 16 can include an interior space 17 (FIG. 1B).

Although the example aerial vehicle 10 shown in FIG. 1A is a multirotor aerial vehicle, the aerial vehicle 10 may be any known type of aerial vehicle. For example, the aerial vehicle 10 may be a fixed-wing aerial vehicle, a dual-rotor aerial vehicle, a vertical take-off and landing vehicle, an aerial vehicle having fixed-wing and multirotor characteristics, etc. The aerial vehicle 10 may be manually controlled via an on-board pilot, at least partially remotely controlled, semi-autonomously controlled, and/or autonomously controlled. For example, the aerial vehicle 10 may be configured to be manually controlled by an on-board human pilot. In some examples, the aerial vehicle 10 may be configured to receive control signals from a remote location and be remotely controlled via a remotely located human pilot and/or a remotely located computer-based controller.

In some examples, operation of the aerial vehicle 10 may be controlled entirely by remote control or partially by remote control. For example, the aerial vehicle 10 may be configured to be operated remotely during take-off and landing maneuvers, but may be configured to operate semi- or fully-autonomously during maneuvers between take-off and landing. In some examples, the aerial vehicle 10 may be an unmanned or uncrewed aerial vehicle that is autonomously controlled, for example, via the vehicle controller, which may be configured to autonomously control maneuvering of the aerial vehicle 10 during take-off from a departure location, during maneuvering in-flight between the departure location and a destination location, and during landing at the destination location, for example, without the assistance of a remotely located pilot or remotely located computer-based controller, or an on-board pilot.

As shown in FIGS. 1B-2B, the aerial vehicle 10 additionally can include a mechanical power source (e.g., an internal combustion engine 18) coupled to the chassis 12. The aerial vehicle also can include a fuel supply 20 (FIG. 2B), which may include a reservoir for containing fuel and a fuel conduit for providing flow communication between the fuel supply 20 and the internal combustion engine 18 for operation thereof. The internal combustion engine 18 may include any type of internal combustion engine configured to convert any type of fuel into mechanical power, such as a reciprocating-piston engine, a two-stroke engine, a three-stroke engine, a four-stroke engine, a five-stroke engine, a six-stroke engine, a gas turbine engine, a rotary engine, a compression-ignition engine, a spark-ignition engine, a homogeneous-charge compression ignition engine, and/or any other known type of engine, though other mechanical power sources can be use without departing from the scope of the present disclosure. The fuel supply 20 may include any type of fuel that may be converted into mechanical power, such as gasoline, gasohol, ethanol, diesel fuel, bio-diesel fuel, aviation fuel, jet fuel, hydrogen, liquefied-natural gas, propane, nuclear fuel, and/or any other known type of fuel convertible into mechanical power by the mechanical power source 18. Although only a single internal combustion engine 18 is shown in FIGS. 1B-2B, the aerial vehicle 10 may include more than one, and the multiple internal combustion engines may be of the same type or of different types, and/or may be configured to operate using the same type of fuel or different types of fuel.

The aerial vehicle 10 also can include an electric power generation device (e.g., a generator 24) coupled to the chassis 12 and the internal combustion engine 18 (e.g., via a rotating shaft) and configured to convert at least a portion of mechanical power supplied by the internal combustion engine 18 into electrical power for use by other components and devices of the aerial vehicle 10. The electrical power generation device can be communicatively coupled to the power source 21 to provide power to charge or recharge the power source 21 upon operation of the internal combustion engine 18. Accordingly, the internal combustion engine 18 can be activated to charge or recharge the power source during flight and help to prolong or extend the flight range/maximum flying time of the aerial vehicle 10.

In some embodiments, the internal combustion engine 18 also can provide mechanical power for a thrust force for the aerial vehicle. For example, as further shown in FIGS. 2A and 2B, the aerial vehicle 10 can include a propulsion member 22 (e.g., a rotor or other suitable airfoil) coupled to the chassis 12 and the internal combustion engine 18 (e.g., via a rotating shaft). The first propulsion member 22 can be coupled to the internal combustion engine 18 for converting at least a portion of the mechanical power supplied by the internal combustion engine 18 into a thrust force. In some embodiments, the first propulsion member 22 can be selectively coupled to the internal combustion engine 18 so that a controller can engage the first propulsion member 22 with the internal combustion engine 18 when powering the first propulsion member 22 with the internal combustion engine 18 is beneficial or desired for the operation of the aerial vehicle 10. In some embodiments, the first propulsion member 22 is positioned in a central portion of the aerial vehicle 10.

The aerial vehicle 10 can include features and/or functionality that are similar or identical to the aerial vehicle shown and described in co-pending U.S. Provisional patent application Ser. No. 17/232,485, filed on Apr. 16, 2021, the disclosure of which is incorporated-by-reference herein.

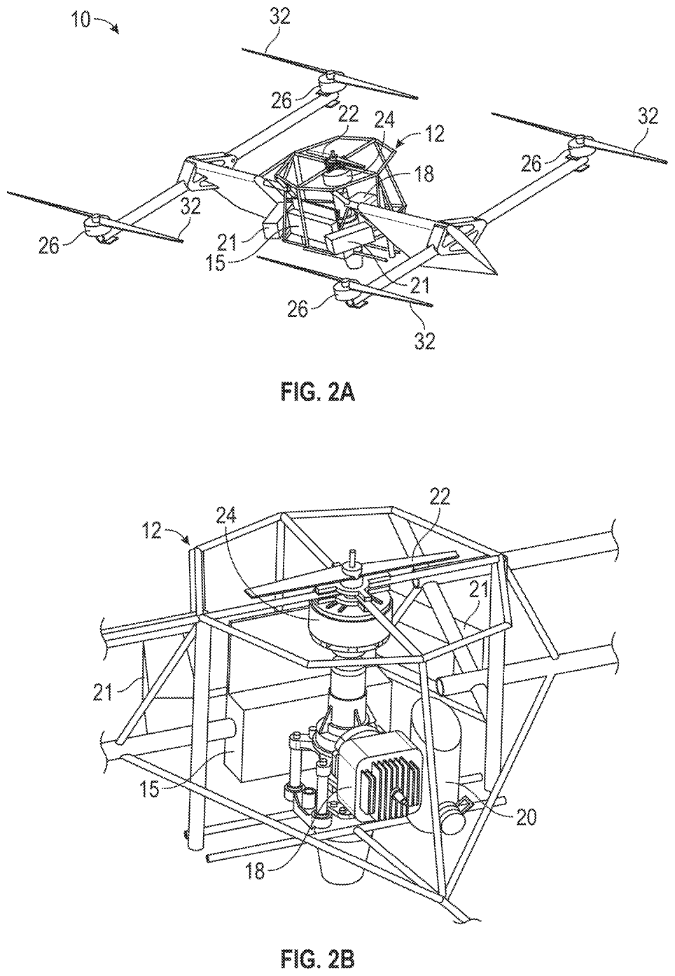

In exemplary embodiments of the disclosure, the internal combustion engine 18 has one or more cylinders or another device that produces exhaust (e.g., combustion products in the form of one or more gases or other fluids). In some embodiments, the exhaust can be in the form of a pulse or a series of pulses pushed into the exhaust header by the one or more cylinders via one or more exhaust valves or ports of the engine (e.g., during an exhaust stroke of the cylinder). Alternatively, the exhaust can be a continuous stream of fluids or a partially continuous stream of fluids. The exhaust fluids from the internal combustion engine 18 can carry energy in the form of pressure waves or sound waves/noise. As schematically shown in FIG. 3, the aerial vehicle 10 can include an exhaust system 40 in fluid communication with the internal combustion engine 18 via an exhaust header 42. In some embodiments, the exhaust system 40 can be at least partially defined in the interior space 13 of the housing and can include one or more exhaust outlets 44. Generally, in the present disclosure, the exhaust system 40 can include one or more chambers with features that can facilitate a reduction in the energy (e.g., sound waves) in the exhaust guided through the exhaust system 40 to help reduce the noise produced by the aerial vehicle 10.

For example, in the embodiment schematically shown in FIG. 3, the exhaust system 40 can include an exhaust chamber 46 in fluid communication with the exhaust header 42 and two exhaust outlets 44 in the outer wall 14 of the housing 11. The exhaust from the internal combustion engine 18 can move through the exhaust chamber 46 from the exhaust header 42 to the exhaust outlets 44 where the exhaust can be communicated out of the exhaust chamber 46 and the housing 11 to the ambient air outside the aerial vehicle 10. In some embodiments, the exhaust chamber 46 can be at least partially sealed off from a remainder of the interior space 13 of the housing 11 by one or more chamber walls 48. For example, the chamber walls 48 can be mounted to the chassis 12 and/or to the outer wall 14 so that an interior 50 of the exhaust chamber 46 is surrounded by the chamber walls 48. In an exemplary embodiment, the chamber walls 48 can extend partially around the interior 50 and a portion of the outer wall 14 can further define the interior 50 of the exhaust chamber 46.

In the exemplary embodiment of FIG. 3, the exhaust chamber 46 is a reactive exhaust chamber with a plurality of reactive elements 52, including but not limited to baffles, panels, or other portions or features configured to interact with the exhaust fluids as they flow through the reactive exhaust chamber 46 from the exhaust header 42. In an exemplary embodiment, the reactive elements 52 are positioned in the reactive exhaust chamber 46 (e.g., mounted to the outer wall 14 of the housing 11 and/or to walls (not shown) of the reactive exhaust chamber 46 in the interior space 13 of the housing 11). The reactive elements 52 are configured to direct sound waves carried in the exhaust fluid to cause certain interactions therebetween and facilitate destructive interference, e.g., so as to cancel out at least a portion of one or more sound waves, and dampen or otherwise reduce the energy carried in the exhaust fluid. Accordingly, these features can help mitigate or reduce in the overall sound profile of the aerial vehicle 10.

As schematically shown in FIG. 3, in one embodiment, each of the reactive elements 52 can include a V-shaped element with two panels extending from a vertex (e.g., at any suitable angle) and are arranged so that the vertices are directed toward the exhaust header 42. The V-shaped reactive elements 52 (e.g., “delta plates”) can be arranged relative to one another so that the space between the respectively adjacent reactive elements 52 is V-shaped as well (e.g., the convex side of one reactive element 52 can face the concave side of an adjacent reactive element 52). Accordingly, the reactive elements 52 can at least partially direct the flow of at least a portion of the exhaust fluid in the reactive exhaust chamber 46 and can help portions of the exhaust fluid to interact with other portions of the exhaust fluid, which can facilitate interference in the sound waves carried by the portions of the exhaust fluid (e.g., the sound waves can at least partially cancel one another out as the portions of the exhaust fluid interact with one another).

For example, the exhaust fluid can enter the reactive exhaust chamber 46 from the exhaust header 42 and engage the first V-shaped reactive element 52 so that the exhaust fluid is divided into portions that move away from one another from the vertex and along the panels of the V-shaped reactive element 52. Subsequently, the portions of the exhaust fluid can interact with the walls of the reactive exhaust chamber 46 and/or additional reactive elements 52 to be redirected and/or further portioned in the reactive exhaust chamber 46 so that portions of the exhaust fluid interact with one another (e.g., in the spaces between the reactive elements 52 and/or elsewhere in the reactive exhaust chamber 46) facilitating destructive interference of the sound waves carried by the portions of the exhaust fluid. Eventually, the exhaust fluid can flow through the exhaust outlets 44 into the ambient air outside the housing 11. The reactive elements 52 and/or other aspects of the reactive exhaust chamber 46 could be otherwise positioned, shaped, arranged, and/or configured without departing from the disclosure. For example, the number and location of the reactive elements 52 can be adjusted in the reactive exhaust chamber 46 and/or the size and/or shape of the reactive exhaust chamber 46 can be adjusted in order to increase or decrease the number of interactions between portions of the exhaust fluid as the exhaust fluid moves through the reactive exhaust chamber 46. In some embodiments, increasing the interactions can reduce the noise in the exhaust fluid as it exits the housing 11 for a quieter operation of the aerial vehicle 10 and can increase the backpressure on the internal combustion engine 18, which can reduce the performance and/or efficiency of the internal combustion engine 18. In some embodiments, the features of the reactive exhaust chamber 46 can be configured to dampen frequencies below 600 Hertz. In a particular embodiment, the reactive exhaust chamber 46 can be configured to dampen frequencies in a range of 30 Hertz to 300 Hertz. Alternatively, the reactive exhaust chamber 46 can be configured to dampen frequencies in any suitable range.

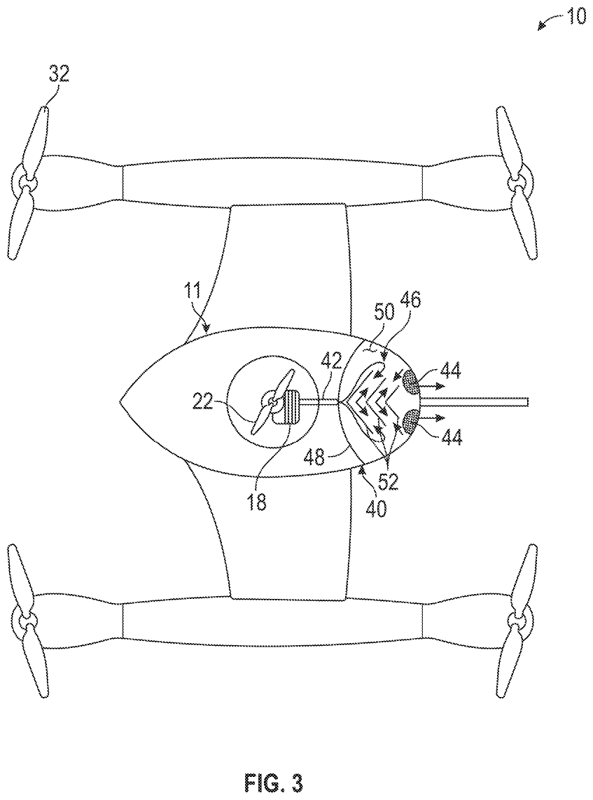

In embodiments shown in FIGS. 4A and 4B, the exhaust system can include a respective reactive chamber 146a, 146c in combination with an absorptive chamber 160. In an exemplary embodiment, an absorptive chamber 160 can include an absorptive material (e.g., fiberglass, glass wool, stainless steel mesh, ceramic absorptive material, steel or stainless steel wool, high pressure acoustic suppression material, and/or any suitable material) that can absorb at least a portion of the sound energy carried in the exhaust fluid as the exhaust fluid passes through the absorptive chamber 160 to help to facilitate a reduction in the overall all sound profile of the aerial vehicle. For example, the absorptive material can convert at least a portion of the sound energy into another form of energy (e.g., heat). The absorptive material can extend on interior surfaces of the absorptive chamber and/or could be otherwise positioned in the absorptive chamber. For example, the absorptive material can be arranged around a perimeter of the absorptive chamber 160 and the absorptive chamber 160 can be configured to direct the exhaust fluid into a center area of the absorptive chamber 160 and to cause the exhaust fluid to expand into the absorptive material arranged around the center portion before the exhaust fluid exits via the exhaust outlets 44. In the embodiments illustrated in FIGS. 4A and 4B, the exhaust fluid first passes through the reactive chamber and then the absorptive chamber of the exhaust system. In some embodiments, the reactive exhaust chamber can be configured generally to dampen frequencies below 600 Hertz and the absorptive chamber can be configured to dampen frequencies above 600 Hertz. Alternatively, the reactive exhaust chamber and/or the absorptive chamber can be configured to dampen frequencies in any suitable range.

In an embodiment of FIG. 4A, the exhaust system 140a can include a reactive exhaust chamber 146a and an absorptive chamber 160 positioned in the housing 11 of the aerial vehicle 10. As shown in FIG. 4A, the exhaust header 42 can extend into the reactive exhaust chamber 146a, which can include a partition 156 and a plurality of reactive elements 52. In an exemplary embodiment, the interior 50 can be at least partially defined by the reactive chamber walls 48 of the reactive exhaust chamber 146a, the partition 156, and an absorptive chamber wall 162, which extends at least partially between the reactive exhaust chamber 146a and the absorptive exhaust chamber 160. In the embodiment shown in FIG. 4A, the exhaust fluid can be redirected by the faces of the V-shaped reactive elements 52 so that portions of the exhaust fluid move in different directions in the interior 50 of the reactive exhaust chamber 146a. The portions of the exhaust fluid can reflect off different surfaces (e.g., the reactive chamber walls 48, the partition 156, the absorptive chamber wall 162, the convex and concave faces of the V-shaped reactive elements 52, and/or other suitable surfaces) to facilitate interactions between portions of the exhaust fluid, which can help reduce the sound energy in the exhaust fluid by at least partially causing destructive interference in the sound waves.

As shown in FIG. 4A, the partition 156 can extend from the wall 48 of the reactive chamber 146a to the absorptive chamber wall 162 to at least partially divide the reactive exhaust chamber 146a into at least two portions. In the illustrated embodiment, the partition 156 can include perforations 158 arranged in any suitable pattern, and the perforations 158 can cause the exhaust fluid to be divided into smaller portions along the dimensions (e.g., length and width) of the partition 156. In exemplary embodiments, the perforations 158 may cause additional reflective interference patterns to form in the respective portions of the reactive exhaust chamber 146a and may create longer paths for the exhaust sound waves to traverse. As shown in FIG. 4A, the reactive exhaust chamber 146a can include two reactive elements 52 (e.g., V-shaped reactive elements) in the first portion and one reactive element 52 (e.g., V-shaped reactive element) in the second portion on the opposite side of the partition 156. Alternatively, any suitable number of reactive elements 52 can be included in the reactive exhaust chamber 146a.

In one embodiment, the exhaust fluid can move into the upstream portion of the reactive exhaust chamber 146a from the exhaust header 42 and portions of the exhaust fluid can be redirected in the interior of the first portion (e.g., by the surfaces of the reactive elements 52, the wall 48 of the reactive exhaust chamber 146b, the absorptive chamber wall 162, and/or the partition 156) to cause interactions between the portions of the exhaust fluid. Portions of the exhaust fluid can be communicated through the perforations 158 into the downstream portion of the reactive exhaust chamber 146a and can be redirected in the downstream portion (e.g., by the reactive element 52, the wall 48, the absorptive chamber wall 162, and the partition 156) to cause interactions between the portions of the exhaust fluid. The reactive exhaust chamber 146a and/or any of its features could be otherwise shaped, positioned, arranged, and/or configured without departing from the disclosure. For example, the reactive exhaust chamber 146a could include any suitable number or arrangement of reactive elements 52 and partitions 156.

In the embodiment of FIG. 4A, the exhaust fluid can move from the reactive exhaust chamber 146a to the absorptive chamber 160 via an opening 164. The exhaust fluid can move through the absorptive chamber 160 to the exhaust outlet 44 in the housing 11. In exemplary embodiments, as the exhaust fluid moves through the absorptive chamber 160, sound energy in the exhaust fluid can be at least partially absorbed by absorptive material positioned in the absorptive chamber 160. The absorptive chamber 160 could be otherwise shaped, positioned, arranged, and/or configured without departing from the disclosure. While in the illustrated embodiments, the reactive exhaust chambers are located upstream from the absorptive chambers, which can allow higher energy fluids to interact in the reactive exhaust chambers before energy is reduced through absorption in the absorptive chambers, an absorptive chamber could be included before a reactive exhaust chamber without departing from the disclosure. In some embodiments, the reactive exhaust chamber 146a and the absorptive chamber 160 could be construed as being portions or sections of one chamber. In other embodiments, the reactive features of the reactive exhaust chamber 146a and the absorptive features of the absorptive chamber 160 could be combined in a single chamber (e.g., into different portions of a single chamber).

In an embodiment shown in FIG. 4B, the exhaust system 140b includes a reactive exhaust chamber 146b and the absorptive chamber 160. As shown in FIG. 4B, the reactive exhaust chamber 146b can include a V-shaped reactive element 52 and a plurality of reactive elements or plates 166 extending from the interior surfaces of at least some of the walls that define the reactive exhaust chamber 146b (e.g., the wall 48 of the reactive exhaust chamber 146b, the absorptive chamber wall 162, and/or other suitable surfaces). In an exemplary embodiment, the reactive plates 166 can be in the form of angled plates extending at any suitable angle from the respective interior surfaces. In some embodiments, the reactive plates 166 can redirect the portions of the exhaust fluid moving in the interior 50 of the reactive exhaust chamber 146b, which can lead to increased interactions between the portions of the exhaust fluid and facilitate more destructive interference in the sound waves in the exhaust fluid. The reactive exhaust chamber 146b could be otherwise shaped, positioned, arranged, and/or configured without departing from the disclosure. For example, the reactive exhaust chamber 146b could include any suitable number or arrangement of reactive elements 52, 166.

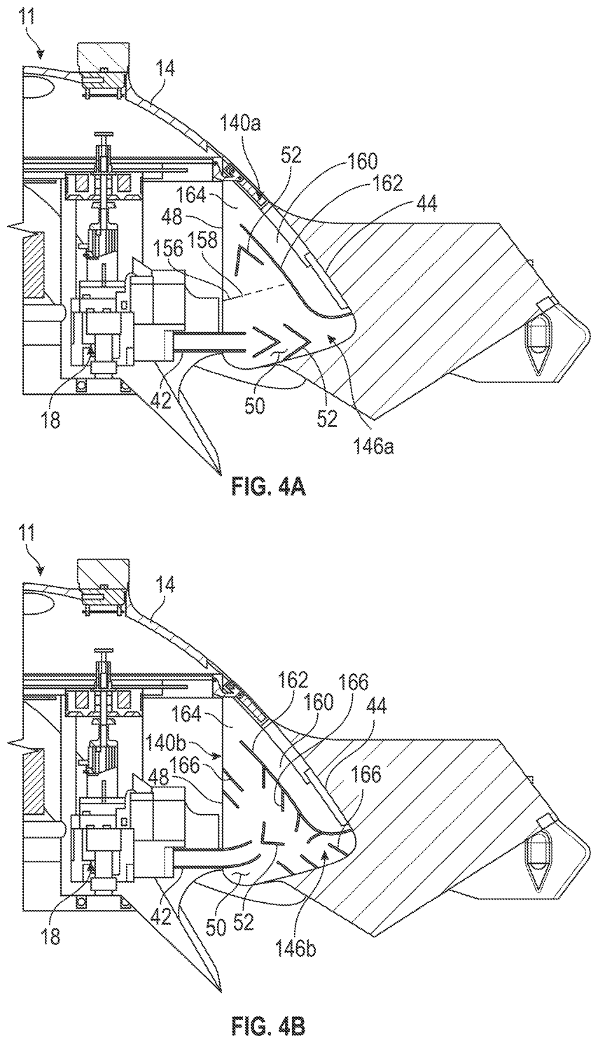

In embodiments such as the one shown in FIG. 5, the exhaust system 240 can include one or more reactive chambers 246 in combination with one or more absorptive chambers 260 similar to the embodiments of FIGS. 4A and 4B except that the absorptive chamber 246 extends in the interior space 17 of the vertical stabilizer 16 in the embodiment of FIG. 5. As shown in FIG. 5, the exhaust outlet is removed from the housing 11 and the absorptive chamber 260 is in fluid communication with the reactive exhaust chamber 246, which is located in the interior space 13 of the housing 11, and with at least one exhaust outlet 244 located at an end of the vertical stabilizer 16.

In the embodiment shown in FIG. 5, the exhaust system 240 can include a reactive exhaust chamber 246 positioned in the housing 11 of the aerial vehicle 10 and an absorptive chamber 260 located in the vertical stabilizer 16. As shown in FIG. 5, the reactive exhaust chamber 246 can include a plurality of reactive plates 166 and one or more inner reactive chamber walls 254 that at least partially define a channel 268. In the illustrated embodiment, the channel 268 can be in fluid communication with the interior 50 of the reactive exhaust chamber 246 at one end and with the absorptive chamber 260 at an opposing end. In an exemplary embodiment, the exhaust fluid can flow from the exhaust header 42 into the interior 50 of the exhaust chamber 246 where the exhaust fluid can interact with the reactive elements 166 and can be divided into portions that interact with one another to facilitate destructive interference of the sound waves carried in the exhaust fluid. Subsequently, the exhaust fluid can flow through the channel 268 and into the absorptive chamber 260 where an absorptive material interacts with the exhaust fluid to absorb at least a portion of the sound energy in the exhaust fluid. The exhaust fluid can flow through the absorptive chamber 260 to the exhaust outlet 244 at the top end of the vertical stabilizer 16 and be communicated to the ambient air outside the aerial vehicle 10. The reactive exhaust chamber 246 and/or the absorptive chamber 260 could be otherwise shaped, positioned, arranged, and/or configured without departing from the disclosure.

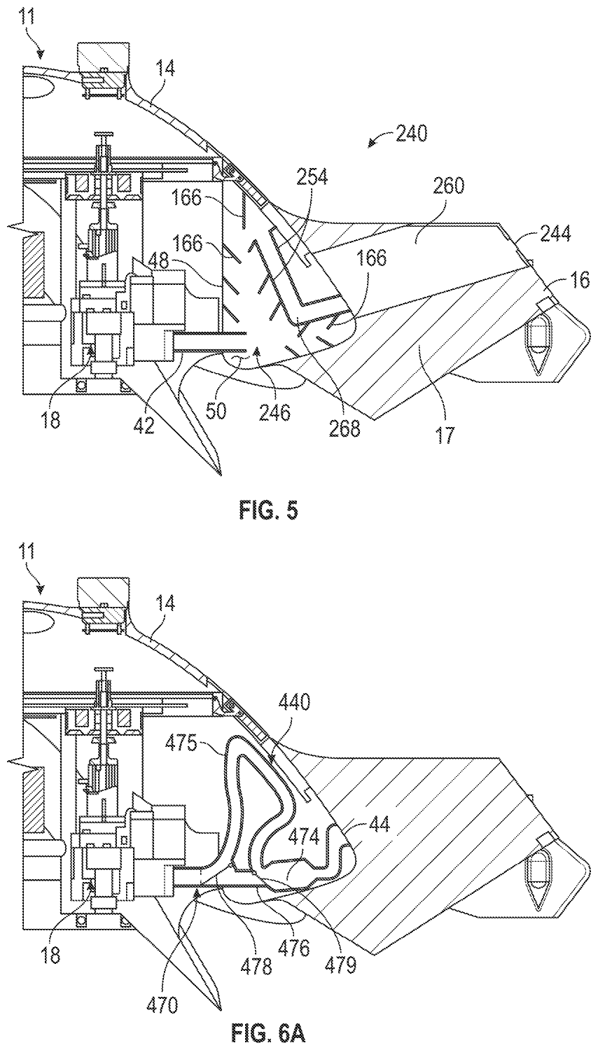

In embodiments shown in FIGS. 6A and 6B, the exhaust system can include a tuned exhaust. In some embodiments, two stroke engines or other suitable engines may use a tuned exhaust system with an expansion chamber to improve its power output by improving its volumetric efficiency. The tuned exhaust system can include a header (e.g., tube) that connects to an expansion chamber and then to an outlet from the expansion chamber. Additional features including noise reduction components may follow the expansion chamber portion in some embodiments. In other embodiments, additional features or complexities such as tapers of the header may also be used. In exemplary embodiments, a parameter considered for tuning the exhaust is the length of the header between the cylinder exhaust port and the expansion chamber. Selection of the length of the header can affect the maximum engine performance at a given engine RPM (revolutions per minute) among other things in some embodiments. Additional factors including exhaust gas temperature and angles of the expansion chamber cones can affect the ideal tuned length once a target RPM is determined.

In the embodiment shown in FIG. 6A, the exhaust system 440 can include a tuned exhaust 470, which can be located in the interior space 13 of the housing 11. In embodiments, the tuned exhaust 470 can be considered to be an exhaust chamber. As shown in FIG. 6A, the tuned exhaust 470a can include a curved or serpentine first tube or header 475, a second tube or header 476 having a different length and/or different shape, and an expansion chamber 474. In the illustrated embodiment, the expansion chamber 474 can include sloped surfaces (e.g., cones) at its upstream and downstream ends and at least a portion (e.g., between the cones) can have a larger diameter than the headers 475, 476. In one embodiment, the exhaust fluids can flow through at least one of the curved first header 475 and the second header 476 and then through the expansion chamber 474 to be tuned by the tuned exhaust 470. Subsequently, the exhaust fluids can flow through the exhaust outlet 44 in the outer wall 14 of the housing 11.

In the embodiment shown in FIG. 6A, the tuned exhaust 470 can include the two exhaust headers 475, 476 having different lengths in combination with diverters that can allow the aerial vehicle to have two or more selectable tuning configurations. During operation of the aerial vehicle, there are cases where it is advantageous to be able to operate the engine at various RPM levels. Some situations may include different power requirements, engine-drive rotor lift requirements, and/or noise level limits. An adjustable or selectable tuned length provides a way to optimize engine performance for different engine RPM targets. In one example, a diverter allows the selection of one of two tuned length headers that flow into a common expansion chamber. This creates two different RPM targets at which the expansion chamber can optimize engine performance in exemplary embodiments. In the embodiment shown in FIG. 6A, two diverters can be used to stop the non-active tuned length header from interacting with the exhaust fluid from either end of the non-active tuned length header. In some embodiments, a single diverter can be used.

As shown in FIG. 6A, the tuned exhaust 470 can include the first header 475 having a first tuned length and the second header 476 having a second tuned length. The tuned exhaust 470 also can include an inlet diverter 478 adjacent the inlets of the headers 475, 476 and an outlet diverter 479 adjacent the outlets of the headers 475, 476. In exemplary embodiments, the diverters 478, 479 can be moved to at least partially close the respective inlets and outlets of the headers 475, 476 in order to select an exhaust configuration (e.g., the first header 475 or the second header 476). For example, as shown in FIG. 6A, the ends of the second header 476 are closed by the respective diverters 478, 479 so that the exhaust fluids can flow through the first header 475 with the first tuned length. Alternatively, as shown in FIG. 6B, the diverters 478, 479 can close the respective ends of the first header 475 so that exhaust fluids can flow through the second header 476 with the second tuned length. It is noted that the first and second headers 475, 476 are shown schematically in FIG. 6B, wherein the shapes and the relative lengths of the headers are not drawn to match the headers of FIG. 6A. Accordingly, the diverts 478, 479 can be operated to direct the exhaust fluids through one of the headers 475, 476. The outlet ends of the headers 475, 476 can be in fluid communication with a common expansion chamber 474 (e.g., when the outlet diverter 479 is in the open position for the respective header 475, 476). In an exemplary embodiment, the diverter flap 585 can be moved by an actuator (e.g., a servo or any other suitable actuator) operated by a controller (e.g., the vehicle controller 15 and/or any other suitable controller(s)). The tuned exhaust 470c could be otherwise shaped, positioned, arranged, and/or configured without departing from the disclosure. For example, one of the diverters 478, 479 could be omitted. Further, the headers 475, 476 could have any suitable shape and/or length. In another example, the tuned exhaust 470 could be in fluid communication with an absorptive chamber (e.g., the absorptive chambers 160, 260 of the prior embodiments or another suitable absorptive chamber) and/or a reactive chamber.

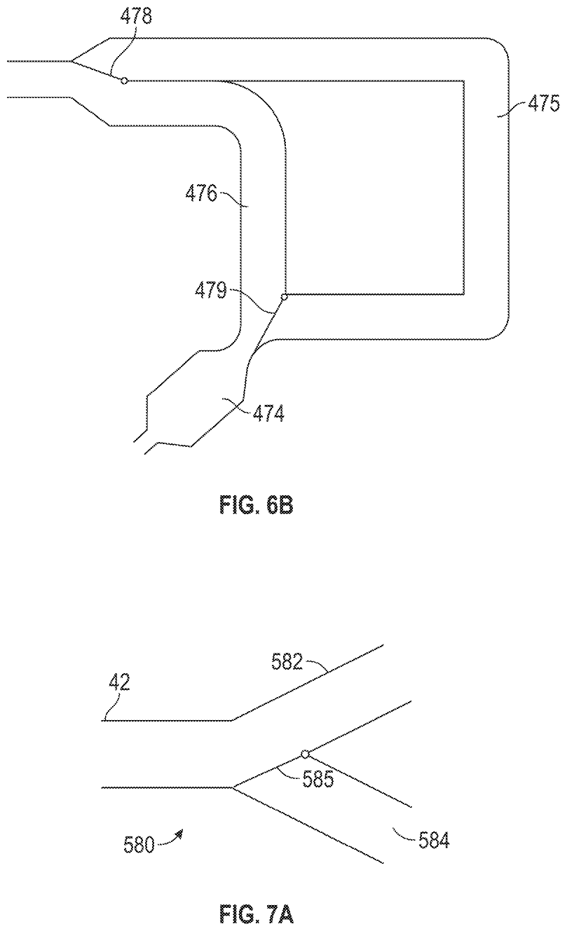

In an embodiment shown in FIGS. 7A and 7B, an exhaust system 540 can include a diverter apparatus 580 in combination with a reactive exhaust chamber 546. In some embodiments, noise reduction (e.g., reactive features, absorptive features, tuning features, and/or other features) can negatively impact other performance characteristics of engines. For example, noise reduction may reduce the fuel efficiency and power to weight ratio of the engine among other things. In some embodiments, it can be advantageous to allow at least a portion of the exhaust gases to bypass some or all components (e.g., noise reduction features) of an exhaust system. The bypass of some or all components may be accomplished by using a flow diverter or an in-line valve, for example.

As shown in FIG. 7A, the diverter apparatus 580 can be in fluid communication with the exhaust header 42. An inlet 582 to the exhaust system (e.g., any suitable exhaust system with noise mitigating features, including but not limited to those shown and described in the present disclosure) and a bypass outlet 584 can extend from the diverter apparatus 580. As shown in FIG. 7A, a diverter flap 585 can be selectively moved to at least partially close the inlet 582 to the exhaust system or the bypass outlet 584. In an exemplary embodiment shown in FIG. 7B, the diverter apparatus 580 is used in combination with a reactive exhaust chamber 546 in fluid communication with the inlet 582 and an exhaust outlet 44 in the outer wall 14 of the housing 11. The reactive exhaust chamber 546 can include a plurality of reactive plates 166 and/or other reactive elements and a partition 556.

In exemplary embodiments, the bypass diverter apparatus 580 may be operated as a binary or analog adjustment. In embodiments with a binary adjustment, the diverter flap 585 can be either on or off so that all the exhaust gases pass through the bypass outlet 584 if on (e.g., with the diverter flap 585 blocking the inlet 582) or all exhaust gases pass through the noise reduction components of the exhaust system (e.g., the reactive exhaust chamber 546) if the bypass is off (e.g., with the diverter flap 585 blocking the bypass outlet 584). Accordingly, the diverter apparatus 580 can be operated to select an exhaust configuration between the bypass outlet 584 or the noise reduction components of the exhaust system. Alternatively, the bypass diverter apparatus 580 may be operated in an analog manner where a ratio of flow is adjusted between the two flow paths. Accordingly, the diverter apparatus 580 can be operated to select an exhaust configuration of a plurality exhaust configurations. In some embodiments, this adjustment could be a function of inputs including nearness to sound sensitive areas and active use of payload components such as speakers or microphones, which may lead to directing more of the exhaust fluids to the reactive exhaust chamber 546 or other systems, and emergency requirements for additional power or efficiency, which may lead to more of the exhaust fluids being directed to the bypass outlet 584. In an exemplary embodiment, the diverter flap 585 can be moved by an actuator (e.g., a servo or any other suitable actuator) operated by a controller (e.g., the vehicle controller 15 and/or any other suitable controller(s)).

The diverter apparatus 580, the bypass outlet 584, and/or the reactive exhaust chamber 546 could be otherwise shaped, positioned, arranged, and/or configured without departing from the disclosure. The diverter apparatus 580 and/or the bypass outlet 584 could be used in conjunction with any of the embodiments shown and described in the present disclosure or in any other suitable embodiments.

In other embodiments, the diverter apparatus 580 could be replaced by internal baffles, reactive elements, and/or exhaust flow valves that can be adjusted to change the noise reduction performance of the exhaust system. In contrast to the diverter apparatus 580, the adjustable baffles, reactive elements, and/or flow valves can at least partially keep the same general flow path while allowing adjustments to the performance effects of the reactive and absorptive chambers and/or other noise mitigating features.

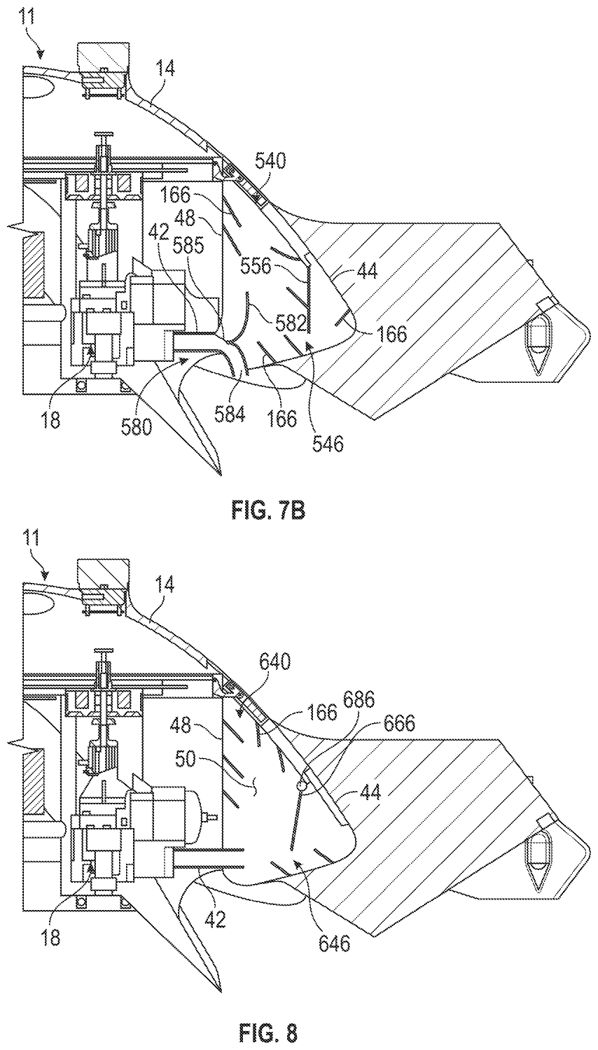

For example, in the embodiment shown in FIG. 8, a reactive exhaust chamber 646 of an exhaust system 640 can include a plurality of reactive plates 166 (e.g., fixed reactive plates) and a movable reactive plate 666 in the interior 50 of the reactive chamber. In some embodiments, the reactive exhaust chamber could include other reactive elements (e.g., V-shaped reactive elements 52). The position of the movable reactive plate 666 can be adjusted in the interior 50 (e.g., about a hinge or pivot 686) to adjust the noise reduction performance of the reactive chamber (e.g., by selecting positions of the movable reactive plate that increase portioning and/or interactions between portions of the exhaust to increase noise reduction or by selecting positions of the movable reactive plate to decrease interactions with the exhaust). In an exemplary embodiment, the moveable reactive plate 666 can be moved by an actuator (e.g., a servo or any other suitable actuator) operated by a controller (e.g., the vehicle controller 15 and/or any other suitable controller(s)). The reactive chamber 646 could be otherwise shaped, positioned, arranged, and/or configured without departing from the disclosure.

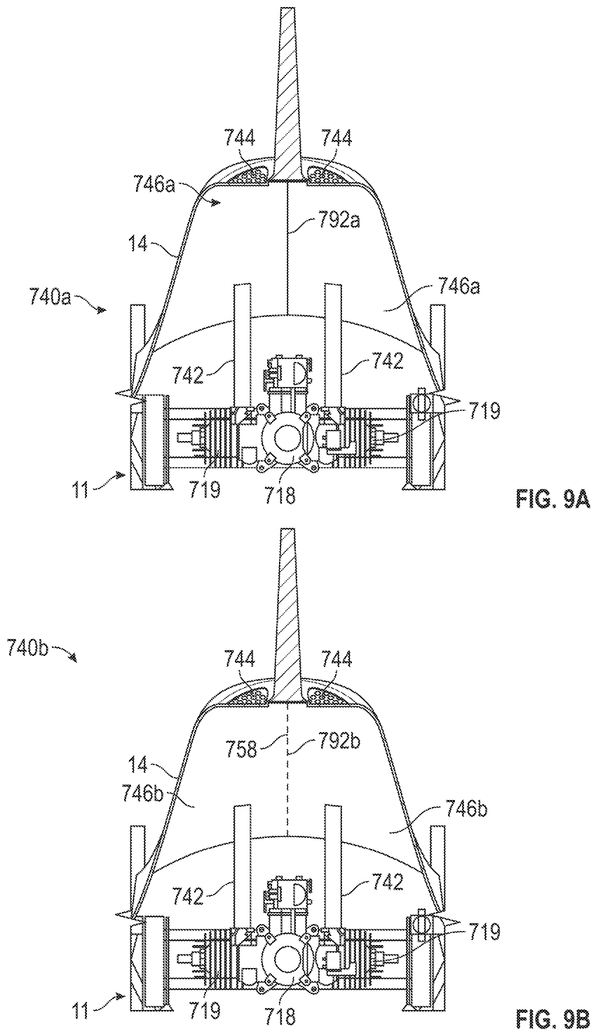

In embodiments shown in FIGS. 9A and 9B, the internal combustion engine 718 can be in the form of an engine having two cylinders 719 (e.g., a twin cylinder engine). In other embodiments, the internal combustion engine can have any suitable number of cylinders. As shown in FIG. 9A, the exhaust of each cylinder 719 of the internal combustion engine 718 can be in fluid communication with a respective exhaust header 742, which can be in fluid communication with the exhaust system 740a. In exemplary embodiments, the exhaust system 740a can include one or more reactive exhaust chambers, one or more absorptive chambers, and/or one or more tuned exhausts. In the embodiment of FIG. 9A, the exhaust system 740a includes a solid partition 792a that at least partially divides the system into two reactive exhaust chambers 746a. In one embodiment, the reactive exhaust chambers 746a are in fluid communication with the respective exhaust headers 742 and with respective exhaust outlets 744. The internal combustion engine 718, the exhaust headers 742, and/or the exhaust system 740a could be otherwise shaped, positioned, arranged, and/or configured without departing from the disclosure.

In an embodiment shown in FIG. 9B, the exhaust system 740b can be similar to the exhaust system 740a of FIG. 9A except that the solid partition 792a is replaced by a perforated partition 792b with a plurality of partitions 758 for allowing at least a portion of the exhaust fluids in the respective reactive exhaust chambers 746b to pass to the other chamber. The internal combustion engine 718, the exhaust headers 742, and/or exhaust systems 740a, 740b could be otherwise shaped, positioned, arranged, and/or configured without departing from the disclosure. For example, either of the partitions 792a, 792b could be omitted. In another example, any of the reactive exhaust chambers, absorptive chambers, and/or tuned exhausts shown and described in the present disclosure and/or other noise mitigating features could be used in conjunction with the embodiments of FIGS. 9A and 9B, such as exemplary configurations including V-shaped reactive elements 52, reactive plates 166, partitions, perforated headers, and/or channels, etc.

In an exemplary embodiment, an advantage of the exhaust systems shown and described in the present disclosure is that the features of the exhaust systems can be arranged in interior spaces (e.g., of the housing 11 and/or the vertical stabilizer 16) that are formed due to other purposes (e.g., aerodynamic, control, aesthetic, and/or other suitable purposes). For example, the interior space can be defined by the outer wall of the housing due to the housing being shaped for aerodynamic, control, aesthetic, and/or other suitable purposes.

Any of the features of the various embodiments of the disclosure can be combined with replaced by, or otherwise configured with other features of other embodiments of the disclosure without departing from the scope of this disclosure. The configurations and combinations of features described above and shown in the figures are included by way of example. For example, any of the reactive exhaust chambers or reactive features shown and described in the present disclosure could be combined with other reactive features and/or any of the absorptive chambers, tuned exhausts, etc. in the present disclosure.

The foregoing description generally illustrates and describes various embodiments of the present invention. It will, however, be understood by those skilled in the art that various changes and modifications can be made to the above-discussed construction of the present invention without departing from the spirit and scope of the invention as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present invention. Accordingly, various features and characteristics of the present invention as discussed herein may be selectively interchanged and applied to other illustrated and non-illustrated embodiments of the invention, and numerous variations, modifications, and additions further can be made thereto without departing from the spirit and scope of the present invention.

What is claimed is:

1. An aerial vehicle, comprising:
a housing comprising an outer wall at least partially defining an interior space;
a mechanical power source at least partially located in the interior space of the housing;
an exhaust header in communication with the mechanical power source for communicating exhaust fluid from the mechanical power source; and
an exhaust system comprising at least an exhaust chamber extending at least partially in the interior space of the housing, the exhaust chamber being in communication with the exhaust header, and the exhaust system comprising an exhaust outlet for communicating the exhaust fluid from the exhaust system outside the aerial vehicle.

2. The aerial vehicle of claim 1, wherein the exhaust chamber comprises a reactive exhaust chamber with one or more reactive elements extending in the reactive exhaust chamber.

3. The aerial vehicle of claim 2, wherein the one or more reactive elements comprise at least a V-shaped element with two panels extending from a vertex.

4. The aerial vehicle of claim 2, wherein the one or more reactive elements comprise a plurality of V-shaped elements arranged in the reactive exhaust chamber so that a convex side of a V-shaped element of the plurality of V-shaped elements faces a concave side of another V-shaped element of the plurality of V-shaped elements.

5. The aerial vehicle of claim 2, wherein the one or more reactive elements comprises a plurality of reactive plates extending from respective walls of the reactive exhaust chamber.

6. The aerial vehicle of claim 2, wherein the reactive exhaust chamber comprises a partition with a plurality of perforations defined therein.

7. The aerial vehicle of claim 2, wherein the one or more reactive elements comprise a movable reactive plate pivotably mounted in the reactive exhaust chamber.

8. The aerial vehicle of claim 1, wherein the exhaust system further comprises an absorptive chamber in communication with the exhaust chamber, the absorptive chamber is configured for absorbing sound energy carried in the exhaust fluid.

9. The aerial vehicle of claim 8, wherein the absorptive chamber extends at least partially within the interior space of the housing.

10. The aerial vehicle of claim 8, further comprising a vertical stabilizer extending from the outer wall of the housing, wherein the interior space is a first interior space, the vertical stabilizer at least partially defines a second interior space, and the absorptive chamber extends at least partially in the second interior space.

11. The aerial vehicle of claim 8, wherein the exhaust chamber comprises a reactive exhaust chamber with one or more reactive elements extending therein.

12. The aerial vehicle of claim 1, wherein the exhaust system comprises a diverter that is movable to select an exhaust configuration of a plurality of exhaust configurations.

13. The aerial vehicle of claim 1, further comprising a diverter apparatus in communication with the exhaust header, wherein the diverter apparatus comprises a diverter flap that is selectively movable to direct the exhaust fluid to at least one of an inlet to the exhaust system and a bypass outlet.

14. The aerial vehicle of claim 1, wherein the exhaust chamber comprises a tuned exhaust comprising a tube in communication with the exhaust header and with an expansion chamber.

15. The aerial vehicle of claim 1, wherein the exhaust chamber comprises a tuned exhaust comprising a first tube, a second tube, an inlet diverter, an outlet diverter, and an expansion chamber, and the inlet diverter and the outlet diverter are operable to direct the exhaust fluid through the first tube or the second tube.

16. The aerial vehicle of claim 1, wherein the mechanical power source is an internal combustion engine having at least two cylinders, the exhaust header is a first exhaust header in communication with at least a first outlet of the internal combustion engine, and the aerial vehicle further comprises a second exhaust header in communication with at least a second outlet of the internal combustion engine.

17. The aerial vehicle of claim 1, wherein the exhaust outlet extends in the outer wall of the housing and in communication with the exhaust chamber.

18. The aerial vehicle of claim 1, wherein the interior space is defined by the outer wall of the housing due to the housing being shaped for at least one of aerodynamic, control, and aesthetic purposes.

19. An exhaust system for an aerial vehicle, the exhaust system comprising:
at least a reactive exhaust chamber in communication with an exhaust header for communicating exhaust fluid from the exhaust header to the reactive exhaust chamber, the reactive exhaust chamber comprising at least a reactive element extending in the reactive exhaust chamber, the reactive element being configured for reducing energy in the exhaust fluids communicated from the mechanical power source to mitigate an overall noise profile of the aerial vehicle; and
an exhaust outlet extending in at least a portion of the aerial vehicle for communicating the exhaust fluid from the exhaust system.

20. The exhaust system of claim 19, wherein the reactive element comprises at least a V-shaped element with two panels extending from a vertex.

21. The exhaust system of claim 19, further comprising a plurality of V-shaped elements arranged in the reactive exhaust chamber so that a convex side of a V-shaped element of the plurality of V-shaped elements faces a concave side of another V-shaped element of the plurality of V-shaped elements.

22. The exhaust system of claim 19, further comprising a plurality of reactive plates extending from respective walls of the reactive exhaust chamber.

23. The exhaust system of claim 22, further comprising a V-shaped element extending in the reactive exhaust chamber and spaced apart from the walls and the plurality of reactive plates.

24. The exhaust system of claim 19, wherein the reactive exhaust chamber comprises a partition with a plurality of perforations defined therein.

25. The exhaust system of claim 24, wherein the reactive element is a first reactive element, and the reactive chamber comprises at least a second reactive element on an opposite side of the partition from the first reactive element.

26. The exhaust system of claim 19, wherein the exhaust system further comprises an absorptive chamber in communication with the reactive exhaust chamber and the exhaust outlet, the absorptive chamber is configured for absorbing sound energy carried in the exhaust fluid.

27. The exhaust system of claim 26, further comprising an absorptive chamber wall extending at least partially between the reactive exhaust chamber and the absorptive chamber.

28. The exhaust system of claim 19, further comprising a diverter apparatus in communication with the exhaust header, wherein the diverter apparatus comprises a diverter flap that is selectively movable to direct the exhaust fluid to at least one of an inlet to the exhaust system and a bypass outlet.

29. The exhaust system of claim 19, wherein the reactive element is configured for redirecting portions of the exhaust fluid so that the portions interact with one another for facilitating destructive interactions between the portions of the exhaust fluid.

30. A tuned exhaust for an aerial vehicle, the tuned exhaust comprising:
an exhaust header for communicating exhaust fluid;
a first tube;
a second tube; and
an expansion chamber;
wherein the tuned exhaust is operable to direct the exhaust fluid from the exhaust header through a selected one of the first tube and the second tube to the expansion chamber.

31. The tuned exhaust of claim 30, further comprising a diverter operable to at least partially close respective ends of the first tube and the second tube.

32. The tuned exhaust of claim 30, further comprising an inlet diverter and an outlet diverter, and the inlet diverter and the outlet diverter are operable to selectively direct the exhaust fluid through the first tube or the second tube.

33. The tuned exhaust of claim 30, wherein the expansion chamber is in communication with the exhaust outlet.

34. The tuned exhaust of claim 30, wherein at least a portion of the expansion chamber has a larger diameter than each of the first tube and the second tube, and the expansion chamber comprises a cone at each of its upstream end and downstream end.

35. A method, comprising:
operating an aerial vehicle comprising:
a housing comprising an outer wall at least partially defining an interior space;
a mechanical power source at least partially located in the interior space of the housing;
an exhaust header; and
an exhaust system comprising at least an exhaust chamber extending at least partially in the interior space of the housing, and an exhaust outlet;
communicating exhaust fluid from the mechanical power source to the exhaust chamber via the exhaust header; and
outputting the exhaust fluid from the exhaust system outside the aerial vehicle via the exhaust outlet.

36. The method of claim 35, wherein the exhaust chamber comprises a reactive exhaust chamber with one or more reactive elements extending in the reactive exhaust chamber, and the method further comprises redirecting portions of the exhaust fluid with the reactive element so that the portions interact with one another for facilitating destructive interactions between the portions of the exhaust fluid.

37. The method of claim 35, wherein the exhaust system further comprises an absorptive chamber in communication with the exhaust chamber, and the method further comprises communicating the exhaust fluid through the absorptive chamber prior to outputting the exhaust fluid and absorbing sound energy carried in the exhaust fluid with an absorptive material in the absorptive chamber.

38. The method of claim 35, wherein the exhaust system comprises a diverter apparatus in communication with the exhaust header, the diverter apparatus comprises a diverter flap, and the method further comprises moving the diverter flap in the diverter apparatus to direct the exhaust fluid to at least one of an inlet to the exhaust system and a bypass outlet.

39. The method of claim 35, wherein the exhaust chamber comprises a tuned exhaust comprising a tube in communication with the exhaust header and with an expansion chamber, and the method further comprises communicating the exhaust fluid through the tube and then through the expansion chamber.

40. The method of claim 35, wherein the exhaust chamber comprises a tuned exhaust comprising a first tube, a second tube, an inlet diverter, an outlet diverter, and an expansion chamber, and the method further comprises moving the inlet diverter and the outlet diverter to close respective ends of the first tube and direct the exhaust fluid through the second tube.
